(19) United States
(12) Patent Application Publication
(10) Pub. No.: US 2026/0179582 A1
(43) Pub. Date: Jun. 25, 2026

(54) DISPLAY PANEL CONTROL METHOD WHICH CAN DYNAMICALLY COMPENSATE DISPLAY PANEL

(71) Applicant: MEDIATEK INC., Hsinchu City (TW)

(72) Inventors: Kuo-Chen Huang, Hsinchu City (TW); Yin-An Jian, Hsinchu City (TW); Cheng-Yen Tsai, Hsinchu City (TW); Ming-Hsien Wu, Hsinchu City (TW); Hsiang-Sheng Tsai, Hsinchu City (TW); Kai-Chen Wang, Hsinchu City (TW)

(73) Assignee: MEDIATEK INC., Hsinchu City (TW)

(21) Appl. No.: 19/001,542

(22) Filed: Dec. 25, 2024

(51) Int. Cl. G09G 5/10

(52) U.S. Cl. CPC G09G 5/10; G09G 2310/08; G09G 2320/045

(57) ABSTRACT

A display panel control method, comprising: (a) computing at least one aging level of a display panel; and (b) selectively using a single pixel compensation method and a multi-pixel sharing compensation method corresponding to the aging level. A display panel control method which pre-adjusts the input image to reduce the increment of aging of the display panel is also disclosed.

### BACKGROUND

The present application relates to a display control method, and particularly relates to a display control method which can improve the aging problem of a display panel.

An aging problem may occur to a display panel if the display panel has been used for a long time. The region of the display panel which has the aging problem may cause the image displayed thereon has an unexpected brightness or a residual image, or any other image problem. In related art, an aging compensation method may be used to improve the aging problem. However, a strong aging compensation method causes high power consumption, needs a large buffering space and may speed up the aging. On the opposite, a weak aging compensation method causes lower power consumption, needs a smaller buffering space, may not speed up the aging but has a weak compensation effect.

Accordingly, a new aging compensation method is needed.

### SUMMARY

One objective of the present application is to provide a display panel control method which can dynamically compensate the display panel.

Another objective of the present application is to provide a display panel control method which can reduce the increment of aging of the display panel.

One embodiment of the present application discloses a display panel control method, comprising: (a) computing at least one aging level of a display panel; and (b) selectively using a single pixel compensation method and a multi-pixel sharing compensation method corresponding to the aging level.

Another embodiment of the present application discloses a display panel control method, comprising: (a) acquiring information of an input image received by a display comprising a display panel; (b) decreasing pixel values of at least portion of the input image according to the information to generate a first output image, to reduce an aging increment of the display panel; and (c) displaying the first output image on the display panel.

In view of above-mentioned, the display panel may be dynamically compensated to improve the aging problem. Also, the image to be displayed may be pre-adjusted to decrease the increment of aging of the display panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a display with an aging compensation mechanism, according to one embodiment of the present application.

FIG. 2-FIG. 6 are schematic diagrams illustrating display panel control methods, according to embodiments of the present application.

FIG. 7 is a flow chart illustrating a display panel control method, according to one embodiment of the present application.

FIG. 8 is a flow chart illustrating a display panel control method, according to another embodiment of the present application.

### DETAILED DESCRIPTION

In the following descriptions, several embodiments are provided to explain the concept of the present application. The term “first”, “second”, “third” in following descriptions are only for the purpose of distinguishing different elements, and do not mean the sequence of the elements. For example, a first device and a second device only mean these devices can have the same structure but are different devices.

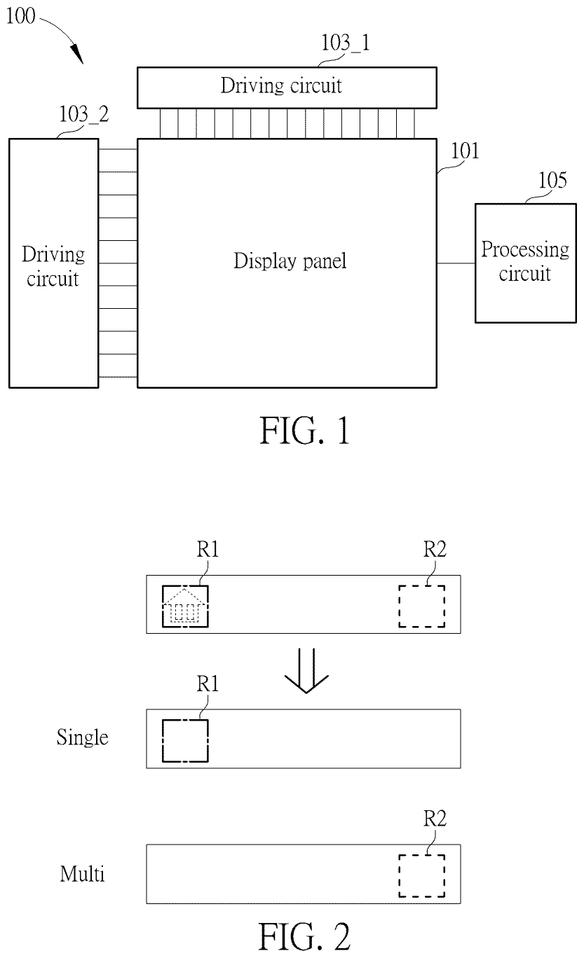

FIG. 1 is a block diagram illustrating a display with an aging compensation mechanism, according to one embodiment of the present application. As shown in FIG. 1, the display 100 comprises a display panel 101, driving circuits 103_1, 103_2 and a processing circuit 105. The display panel 101 comprises a plurality of pixel circuits. The driving circuits 103_1, 103_2 are configured to receive an input image and configured to control the display panel 101 to display an output image corresponding to the input image. The parameters of the input image, such as pixel values of pixels in the input image, may be the same as which of the output image. However, the input image may be adjusted before being displayed such that the parameters of the input image and the output image are different.

The processing circuit 105, such as a processor, is configured to adjust the input image to generate the output image. In other words, the processing circuit 105 performs a display control method to display an output image corresponding to the input image, thereby the effect caused by the panel aging can be improved. Please note, in the embodiment of FIG. 1, the processing circuit 105 is coupled to the display panel 101. However, the processing circuit 105 can be coupled to the driving circuits 103_1, 103_2, to control the display panel 101.

FIG. 2-FIG. 6 are schematic diagrams illustrating display panel control methods, according to embodiments of the present application. In the embodiments of FIG. 2-FIG. 4, at least one aging level of the display panel 101 is computed. Also, a single pixel compensation method and a multi-pixel sharing compensation method is selectively used corresponding to the aging level. The single pixel compensation method means that each pixel has a corresponding compensation value and is adjusted using the compensation value. For example, if the single pixel compensation method is used to a region of the input image, all pixels in the region respectively has a corresponding compensation value and are adjusted by using these compensation values. Such method may have a relative strong compensation ability but may cause higher power consumption and a larger buffering space is needed to store the compensation values.

Oppositely, the multi-pixel sharing compensation method means that several pixels share a corresponding compensation value and are adjusted using the compensation value. For example, if the multi-pixel sharing compensation method is used to a region of the input image, which comprises pixels P1, P2, P3, P4, P5 and P6. The pixels P1, P2, P3 in the region respectively shares a first compensation value and are adjusted by using the first compensation values. Also, the pixels P4, P5, P6 in the region respectively shares a second compensation value and are adjusted by using the second compensation values. Such method may have a relative weak compensation ability, causes lower power consumption and a smaller buffering space is needed to store the compensation values.

In the embodiment of FIG. 2, a level variation of aging levels of each of a plurality of regions of the display panel is computed.

The region which has the level variation higher than a first variation threshold (i.e., the level variation is large) is compensated by the signal pixel compensation method and not by the multi-pixel sharing compensation method. Besides, the region which has the level variation lower than the first variation threshold (i.e., the level variation is small) is compensated by the multi-pixel sharing compensation method but not by the signal pixel compensation method. For example, the region R1 of the display panel 101 has a larger level variation and the region R2 of the display panel 101 has a smaller level variation. Accordingly, the region R1 is compensated by the single pixel compensation method but not by the multi-pixel sharing compensation method. On the contrary, the region R2 is compensated by the multi-pixel sharing compensation method but not by the single pixel compensation method.

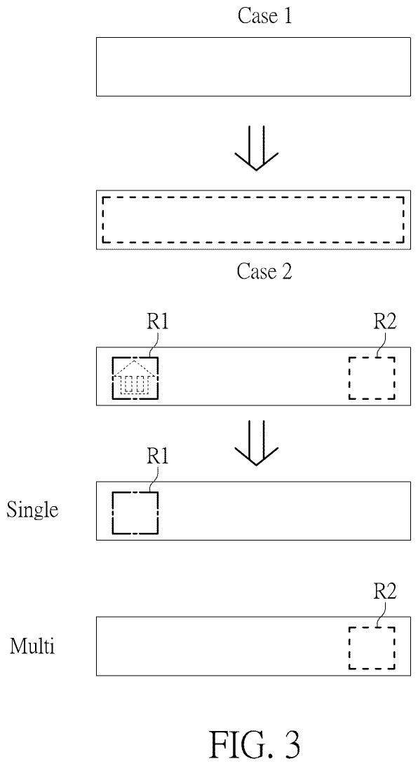

In the embodiment of FIG. 3, an aging level of a whole region of the display panel 101 is computed. If the aging level is lower than a first aging threshold (i.e., the aging level is low), the display panel 101 is compensated by the multi-pixel sharing compensation method and not by the single pixel compensation method. On the contrary, if the aging level is higher than the first aging threshold (i.e., the aging level is high), the display panel 101 is compensated by the single pixel compensation method and the multi-pixel sharing compensation method. For example, in the case 1 in FIG. 3, the aging level is low, thus the display panel 101 is compensated by the multi-pixel sharing compensation method but not by the single pixel compensation method. In case 2, both the single pixel compensation method and the multi-pixel sharing compensation method are used, the same as the embodiment of FIG. 2.

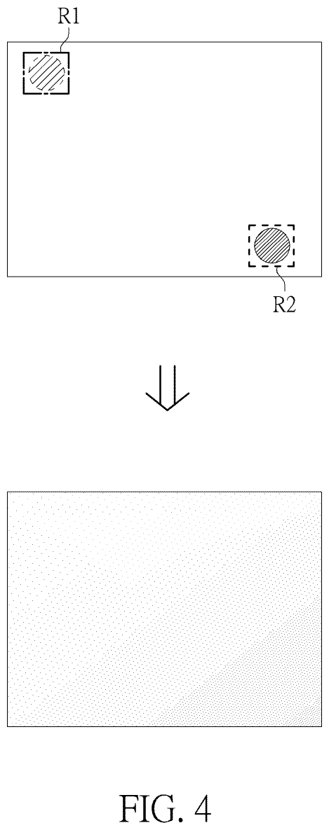

In the embodiment of FIG. 4, the compensation value is dynamically adjusted corresponding to the aging level. For a region has a lower aging level, an initial compensation value is used. Oppositely, for a region has a higher aging level, the initial compensation value is adjusted to be lower. For more detail, a first aging level of a first region (e.g., the region R1 in FIG. 4) of the display panel 101 and a second aging level of a second region (e.g., the region R2 in FIG. 4) of the display panel 101 are computed. The first aging level is lower than the second aging level. Further, the initial compensation value of the region R1 and the region R2 are respectively a first compensation value and a second compensation value. In such case, the first compensation value is still used to compensate the first region R1 since the region R1 has a lower aging level. On the opposite, the second compensation value is adjusted to be lower based on the initial second compensation value, since the region R2 has a higher aging level.

In one embodiment, the first region is compensated by the first compensation value to have a first pixel value distribution and the second region is compensated by the second compensation value to have a second pixel value distribution lower than the first pixel value distribution. The pixel value distribution may mean a maximum pixel value, a minimum pixel value or an average pixel value. Also, regions between the first region and the second region are further adjusted according to a difference between the first pixel value distribution and the second pixel value distribution.

In one embodiment, if the output image which is generated by adjusting the input image via the steps shown in FIG. 4 is displayed, the output image may have a gradient background as shown in FIG. 4. By this way, users will be less aware of the difference between the two ranges which are compensated, thus the user experience is improved. The variation rate of the gradient background may be changed by setting the variation rate of the pixel values from the first region R1 to the second region R2. The higher the variation rate of the pixel values, the higher the variation rate of the gradient background. On the opposite, the lower the variation rate of the pixel values, the lower the variation rate of the gradient background.

Briefly, in the embodiment of FIG. 2, the location or the size of the region of the display panel 101 which uses the multi-pixel sharing compensation method may correspond to the aging levels of different regions of the display panel 101. Also, in the embodiment of FIG. 2, the location or the size of the region of the display panel 101 which uses the single pixel compensation method may correspond to the aging levels of different regions of the display panel 101. In the embodiment of FIG. 3, the location or the size of the region of the display panel 101 which uses the multi-pixel sharing compensation method may correspond to the aging level of the whole display panel 101. Besides, in the embodiment of FIG. 3, the single pixel compensation method may be selectively used corresponding to the aging level of the whole display panel 101. In FIG. 4, if the input image which has pixels with the same values is input to the display 100, pixel values of the output image displayed on the display panel 101 may correspond to the aging levels of the regions.

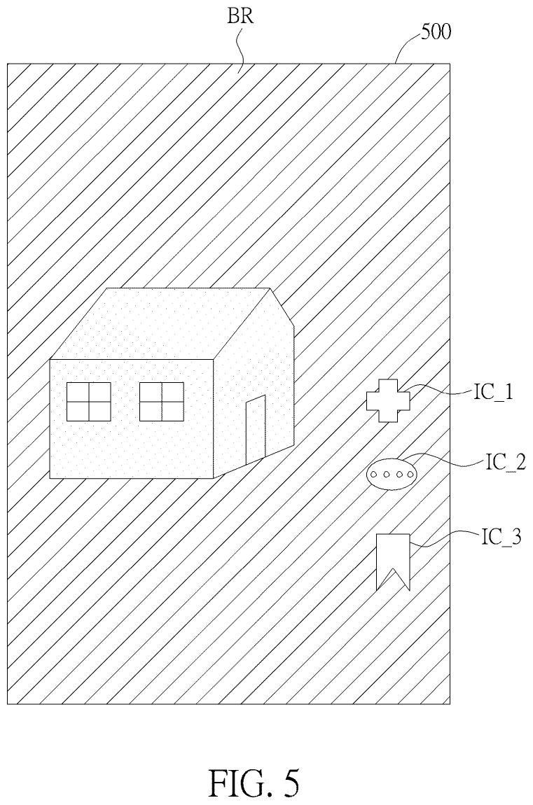

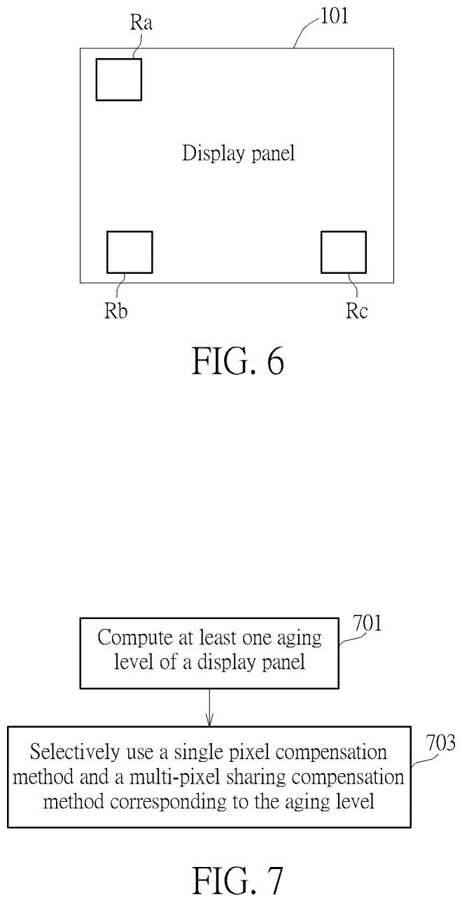

In the embodiments of FIG. 2-FIG. 4, at least one aging level for a portion of the display panel 101 or for a whole region of the display panel 101 is acquired, and the display panel 101 is compensated according to the aging level. In the embodiments of FIG. 5-FIG. 6, the aging level for the display panel 101 may not be computed, and the input image is pre-adjusted to reduce the aging level increment. For more detail, in such embodiment, the information of the input image is acquired. Next, pixel values of at least portion of the input image are decreased according to the information of the input image to generate the output image, to reduce an aging increment of the display panel.

In following embodiment, the “first output image” means an output image which is generated by adjusting the input image, and the “second output image” means an output image which is the same as the input image. In other words, if the second output image is displayed, it means the input image is not adjusted yet and is directly displayed. In another embodiment, the second output image is generated according to the input image without decreasing pixel values of the input image, but may be processed by other image processing.

In the embodiment of FIG. 5, the information comprises pixel values of at least one region of the input image, and the pixel values of the region (a specific region) which has the pixel values larger than a pixel value threshold are decreased, to reduce an aging increment of the display panel. In one embodiment, the information further comprises the display time of the pixel values in a predetermined time period. For example, the region A has a display time Ta of pixel values A1 . . . An in the predetermined time period Tp, and the region B has a display time Tb of pixel values B1 . . . Bn in the predetermined time period Tp. However, the information of FIG. 5 is not limited to these examples.

In FIG. 5, the input image is not adjusted yet, thus the display 500 shows the second output image. The second output image has icon regions IC_1, IC_2, IC_3 and other regions such as background regions BR. The pixel values of the icon regions IC_1, IC_2, IC_3 are higher than the back ground regions BR. Accordingly, the pixel values of the icon regions IC_1, IC_2, IC_3 of the input image are decreased to reduce the aging increment of the display panel. In one embodiment, the pixel values of the icon regions IC_1, IC_2, IC_3 are decreased corresponding to the initial pixel values thereof. The higher the original pixel values, the more the pixel values will be reduced. On the contrary, the lower the original pixel values, the less the pixel values will be reduced

In another embodiment, pixel values of at least one region of the input image are computed, and the display panel control method further comprises computing display time of at least one target region of the second output image which have pixel values larger than the pixel value threshold. The display panel control method decreases pixel values of regions of the input image which correspond to the target region according to the display time to generate the first output image. For example, in FIG. 5, the input image may not be adjusted yet, thus the display 500 shows the second output image which is the same as the input image. The display time of the icon regions IC_1, IC_2 and IC_3 in the second output image are computed, and the pixel values of the icon regions IC_1, IC_2 and IC_3 of the input image are decreased according to the display time.

The embodiment illustrated in FIG. 5 may be combined with the embodiments of FIG. 2-FIG. 4. For example, in the embodiment of FIG. 6, the region Ra is a high pressure region but has no aging problem. Besides, the region Rb is not a high pressure region but has an aging problem. The high pressure regions mean the regions which tend to display images with high pixel values. The regions Ra and Rb may be compensated by the methods shown in FIG. 2-FIG. 4, and pixel values thereof are not pre-decreased. Also, the region Rc has the aging problem and is a high pressure region, thus the pixel values of the region Rc are decreased.

In another embodiment, the information comprises which application generated the input image, and the display control method decreases pixel values of at least portion of the input image according to a type of the application. For example, if the application needs an accurate color, such as a drawing application, the display control method does not decrease pixel values. For another example, if the usage time of the application is always short, such as a bank application, the display control method does not decrease pixel values. For another example, if the application always has region with high pixel values, such as an audio-visual application, the display control method decreases pixel values. For still another example, if the application always displays a still image, such as a focus application, the display control method decreases pixel values.

In view of the embodiments of FIG. 2-FIG. 4, a display panel control method can be acquired. FIG. 7 is a flow chart illustrating a display panel control method, according to one embodiment of the present application, which comprises following steps:

### Step 701

Compute at least one aging level of a display panel (e.g., the display panel 101 in FIG. 1).

### Step 703

Selectively use a single pixel compensation method and a multi-pixel sharing compensation method corresponding to the aging level.

The embodiments illustrated in FIG. 5 and FIG. 6 may also be applied to the display panel control method shown in FIG. 7. Accordingly, the display panel control method in FIG. 7 may further comprises: acquiring information of the input image; and decreasing pixel values of at least portion of the input image according to the information to generate the output image, to reduce an aging increment of the display panel. Besides, the display panel control method in FIG. 7 may further comprises: computing display time of at least one target region of the output image which have pixel values larger than the pixel value threshold; wherein pixel values of the target region are decreased according to the display time to generate the first output image.

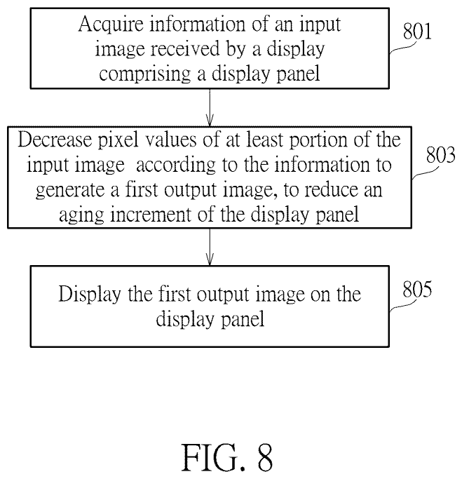

In view of the embodiments of FIG. 5 and FIG. 6, a display panel control method can be acquired. FIG. 8 is a flow chart illustrating a display panel control method, according to another embodiment of the present application, which comprises following steps:

### Step 801

Acquire information of an input image received by a display comprising a display panel(e.g., the display panel 101 in FIG. 1).

### Step 803

Decrease pixel values of at least portion of the input image according to the information to generate a first output image, to reduce an aging increment of the display panel.

### Step 805

Display the first output image on the display panel.

In view of above-mentioned, the display panel may be dynamically compensated to improve the aging problem. Also, the image to be displayed may be pre-adjusted to decrease the increment of aging of the display panel.

Those skilled in the art will readily observe that numerous modifications and alterations of the device and method may be made while retaining the teachings of the invention. Accordingly, the above disclosure should be construed as limited only by the metes and bounds of the appended claims.

1. A display panel control method, comprising:
(a) computing at least one aging level of a display panel; and
(b) selectively using a single pixel compensation method and a multi-pixel sharing compensation method corresponding to a distribution of the aging level.

2. The display panel control method of claim 1, wherein the step (a) comprises:
computing a level variation of aging levels of each of a plurality of regions of the display panel;
wherein the step (b) comprises:
using the single pixel compensation method but not using the multi-pixel sharing compensation method to compensate the region which has the level variation higher than a first variation threshold; and
using the multi-pixel sharing compensation method but not using the single pixel compensation method to compensate the region which has the level variation lower than the first variation threshold.

3. The display panel control method of claim 1, wherein the step (a) comprises:
computing an aging level of a whole region of the display panel;
wherein the step (b) comprises:
using the multi-pixel sharing compensation method but not using the single pixel compensation method to compensate the display panel if the aging level is lower than a first aging threshold; and
using the single pixel compensation method and the multi-pixel sharing compensation method to compensate the display panel if the aging level is higher than the first aging threshold.

4. The display panel control method of claim 1, wherein the step (a) comprises:
computing a first aging level of a first region of the display panel and a second aging level of a second region of the display panel; and
using a first compensation value to compensate the first region and a second compensation value to compensate the second region, wherein when the second aging level is higher than the first aging threshold, the second compensation value is adjusted to be lower based on the second aging level.

5. The display panel control method of claim 4, wherein the first region is compensated by the first compensation value to have a first pixel value distribution and the second region is compensated by the second compensation value to have a second pixel value distribution lower than the first pixel value distribution, wherein regions between the first region and the second region are further adjusted according to a difference between the first pixel value distribution and the second pixel value distribution.

6. The display panel control method of claim 4, further comprising:
displaying an output image on a display comprising the display panel corresponding to an input image received by the display;
wherein the output image has a gradient background after the first region has been compensated by the first compensation value, the second region has been compensated by the second compensation value, and the regions between the first region and the second region has been adjusted according to the difference between the first pixel value distribution and the second pixel value distribution.

7. The display panel control method of claim 1, further comprising:
(c) acquiring information of the input image;
(d) decreasing pixel values of at least portion of the input image according to the information to generate the output image, to reduce an aging increment of the display panel.

8. The display panel control method of claim 7, wherein the information comprises pixel values of at least one region of the input image, and the step (d) decreases the pixel values of a specific region of the input image which has the pixel values larger than a pixel value threshold.

9. The display panel control method of claim 8, wherein the step (d) decreases the pixel values of the specific region when the specific region is displayed on a region of the display panel which has an aging problem, and does not decreases the pixel values of the specific region when the specific region is displayed on a region of the display panel which does not have the aging problem.

10. The display panel control method of claim 7,
wherein the information comprises pixel values of at least one region of the input image,
wherein the display panel control method further comprises computing display time of at least one target region of the output image which have pixel values larger than the pixel value threshold;
wherein the step (d) decreases pixel values of the target region according to the display time to generate the first output image.

11. The display panel control method of claim 7, wherein the information comprises which application generated the input image, and the step (b) decreases pixel values of at least portion of the input image according to a type of the application.

12-16. (canceled)
